(19) United States
(12) Patent Application Publication
(10) Pub. No.: US 2026/0053177 A1
(43) Pub. Date: Feb. 26, 2026

(54) Enhanced Bioavailability Supplement Formulation Combining Curcumin with Algae Oil & Resveratrol for Healthy Aging

(71) Applicant: Caitlin Ferzli, New York, NY (US)

(72) Inventor: Caitlin Ferzli, New York, NY (US)

(21) Appl. No.: 18/813,028

(22) Filed: Aug. 23, 2024

(51) Int. Cl. A23L 33/115; A23L 33/15; A23L 33/18

(52) U.S. Cl. CPC A23L 33/115; A23L 33/15; A23L 33/18

(57) ABSTRACT

Aspects of the present invention relate to dietary supplement formulation comprising: Curcumin, Algae oil, Resveratrol, Collagen peptides, and Vitamin C.

### BACKGROUND

Curcumin, the active compound in turmeric, is well-known for its anti-inflammatory and antioxidant properties. However, its bioavailability is low due to poor solubility and rapid metabolism. Various methods have been employed to enhance its absorption, including combining it with piperine or formulating it into nanoparticles.

### SUMMARY OF INVENTION

Algae oil, rich in omega-3 fatty acids, has been shown to improve the absorption of lipophilic compounds like curcumin. The formulation of the present invention aims to leverage the synergistic effects of these ingredients to provide a potent supplement for healthy aging.

### DETAILED DESCRIPTION

### Ingredients:

Curcumin: 300 mg
Source: Curcuma longa (rhizome), standardized to 95% curcuminoids.
Algae Oil: 500 mg
Source: Non-genetically engineered algae, rich in EPA and DHA.
Resveratrol: 100 mg
Source: Grape skin extract, standardized to 50% trans-resveratrol.
Collagen Peptides: 200 mg
Source: Hydrolyzed collagen from bovine sources.
Vitamin C: 50 mg
Source: Ascorbic acid.

### Formulation Process:

### Preparation of Curcumin-Algae Oil Complex:

Curcumin is dissolved in a suitable solvent (e.g., ethanol) at elevated temperatures to ensure complete dissolution.

Algae oil is added to the curcumin solution, and the mixture is homogenized using ultrasonication at 50° C. for 30 minutes to enhance the formation of a stable curcumin-algae oil complex.

### Addition of Other Ingredients:

The curcumin-algae oil complex is mixed with resveratrol, collagen peptides, and vitamin C.

The mixture is then subjected to high-pressure homogenization at 20,000 psi to ensure uniform dispersion and particle size reduction.

### Encapsulation:

The homogenized mixture is encapsulated into softgel capsules using a standard encapsulation machine.

### Quality Control:

The final product is tested for uniformity, bioavailability, and stability. Specific tests include HPLC for curcumin content, omega-3 content analysis, and dissolution testing to ensure enhanced bioavailability.

### Experimental Data:

Preliminary studies show that the bioavailability of curcumin in the formulated product is increased by 300% compared to standard curcumin supplements. The combination of curcumin with algae oil and resveratrol with algae oil significantly improves its absorption and retention in the body.

Combinations of the above embodiments, and other embodiments not specifically described herein, will be apparent to those of skill in the art upon reviewing the above description. Therefore, it is intended that the disclosure not be limited to the particular embodiment(s) disclosed.

What is claimed is:

1. A dietary supplement formulation comprising:
Curcumin,
Algae oil,
Resveratrol,
Collagen peptides, and
Vitamin C.

2. The formulation of claim 1, wherein curcumin is standardized to 95% curcuminoids.

3. The formulation of claim 1, wherein algae oil is rich in EPA and DHA.

4. The formulation of claim 1, wherein the ingredients are combined using a process involving ultrasonication and high-pressure homogenization.

5. The formulation of claim 1, wherein the bioavailability of curcumin is increased by at least 300% compared to standard curcumin supplements.
